(19) United States
(12) Patent Application Publication
(10) Pub. No.: US 2026/0264618 A1
(43) Pub. Date: Sep. 10, 2026

(54) COVERING SHELF APPARATUS FOR VEHICLE

(71) Applicants: HYUNDAI MOTOR COMPANY, SEOUL (KR); KIA CORPORATION, SEOUL (KR); SEOYON E-HWA CO., LTD., Anyang-si (KR); DAEDONG SYSTEM CO., LTD., Incheon (KR)

(72) Inventors: Soonsung Park, Hwaseong-si (KR); Kisung Kim, Hwaseong-si (KR); Jung Won Yun, Uiwang-si (KR); Jae Moon Jeong, Namyangju-si (KR); Won Min Lee, Incheon (KR)

(73) Assignees: HYUNDAI MOTOR COMPANY, SEOUL (KR); KIA CORPORATION, SEOUL (KR); SEOYON E-HWA CO., LTD., Anyang-si (KR); DAEDONG SYSTEM CO., LTD., Incheon (KR)

(21) Appl. No.: 19/246,395

(22) Filed: Jun. 23, 2025

(30) Foreign Application Priority Data
Mar. 6, 2025 (KR) 10-2025-0028791

(51) Int. Cl. B60R 5/04

(52) U.S. Cl. CPC B60R 5/045

(57) ABSTRACT

A covering shelf apparatus for a vehicle includes shelf sides, a covering shelf, and an actuator. The shelf sides are at left and right sides of a luggage compartment, respectively. The actuator is at one shelf side of the plurality of shelf sides and is configured to move the covering shelf to uncover or cover the luggage compartment. The actuator includes a carrier, a guide rail, a cable, and a driver. The carrier is configured to be connected to a first portion of the covering shelf. The guide rail is configured to be coupled to the shelf sides. The carrier is configured to be movably mounted to the guide rail. A first end of the cable is configured to be connected to the carrier. A second end of the cable is a free end. The driver is configured to push/pull the cable to cover or uncover the luggage compartment.

### CROSS-REFERENCE TO RELATED APPLICATION

This present application claims the benefit of and priority to Korean Patent Application No. 10-2025-0028791, filed on March 6, 2025, in the Korean Intellectual Property Office, the entire disclosure of which is incorporated herein by reference.

### TECHNICAL FIELD

The present disclosure relates to a covering shelf apparatus for a vehicle. More particularly, the present disclosure relates to a covering shelf apparatus for a vehicle configured to shield a passenger compartment, in which a passenger rides, and a luggage compartment from each other.

### BACKGROUND

Hatchback type vehicles such as sport utility vehicles (SUVs) and crossover utility vehicles (CUVs) are not equipped with a separate luggage compartment. Instead, such vehicles use a space between a rear seat and a tailgate as a luggage compartment. Accordingly, a covering shelf configured to shield a passenger compartment, in which a passenger rides, and a luggage compartment from each other is provided between a rear seat and a tailgate.

Generally, a system for covering a motor-vehicle luggage compartment includes a front flap, a rear flap, a support, and a drive means.

The front flap is pivotably coupled to the support. The front flap and the rear flap are pivotably coupled to each other. A guide rail is mounted to the support. A shaft of the rear flap is movably mounted to the guide rail.

The drive means is mounted on the support. The drive means includes a carriage, a band, and a gear. The shaft of the rear flap is rotatably mounted on the carriage. The carriage is fixed to the band, which has a closed loop shape. The band is engaged with pulleys respectively provided at ends of the rail. The gear slidably moves the carriage. As the carriage linearly moves along the rail, the front flap and the rear flap are folded or unfolded to open or close a luggage compartment.

In another example system for covering a luggage compartment of a motor vehicle, the system includes lateral supports, a front panel, a rear panel, a carriage, a cable, and a wheel.

The front panel and the rear panel are pivotably coupled to the lateral supports, respectively. The carriage is slidably mounted on the guide rail. The cable is engaged with pulleys at opposite sides of a movement range of the carriage. The cable is rotated by frictional interaction with the wheel, which rotates.

In accordance with the above examples, it may be possible to variously change a path of the cable by disposing the pulleys (the wheel or a drum) at positions where the direction of the cable (the band) is changed. However, the path along which the carriage moves is limited to a straight path because the carriage (carrier) configured to move the panels (flaps) cannot pass through the pulleys. In addition, since the cable forms a closed loop wound around a plurality of pulleys, the cable may have a length corresponding to 2 times or more the movement range of the carriage.

The center of gravity of each panel in a state in which the covering shelf closes the luggage compartment (a flat state of the covering shelf) is spaced apart from a point at which each panel pivots by a great distance in a horizontal direction.

Furthermore, static frictional force is greater than kinetic frictional force. Accordingly, the greatest load is applied to a motor when the covering shelf starts to open the luggage compartment. Thus, the greatest load is generated at the motor when the covering shelf starts to open the luggage compartment in a flat state thereof. Therefore, a scheme for reducing load in an initial stage of operation (when the covering shelf starts to open the luggage compartment) is desired.

### SUMMARY

The present disclosure is directed to addressing the above-mentioned technical issues, for application to a covering shelf apparatus for a vehicle configured to shield a passenger compartment, in which a passenger rides, and a luggage compartment from each other.

The present disclosure is directed to providing a covering shelf apparatus for a vehicle which is capable of minimizing the length of a cable, reducing the number of parts, and achieving structural simplification and weight reduction by optimizing the structure of an actuator configured to move a covering shelf.

In addition, the present disclosure is directed to providing a covering shelf apparatus for a vehicle which is capable of reducing load in an initial stage of operation and reducing motor output and noise by optimizing the structure of a guide rail configured to guide movement of a carrier.

In addition, the present disclosure is directed to providing a covering shelf apparatus for a vehicle which enables application of a guide rail having various shapes. Thus, the cover apparatus prevents interference of the guide rail with other parts while realizing various designs and satisfying aesthetic senses of passengers.

The present disclosure is not limited to the above. Other technical aspects not mentioned above should be clearly understood by those having ordinary skill in the art from the following description.

In an example, a covering shelf apparatus for a vehicle disclosed in the present disclosure may include shelf sides, a covering shelf, and an actuator.

In an example, the shelf sides may be provided at left and right sides of a luggage compartment, respectively.

In an example, the actuator may be provided at one of the plurality of shelf sides and may be configured to move a covering shelf to enable the covering shelf to uncover or cover the luggage compartment.

In an example, the actuator may include a carrier, a guide rail, a cable, and a driver.

In an example, the carrier may be configured to be connected to a first portion of the covering shelf.

In an example, the guide rail may be configured to be coupled to a respective shelf side of the plurality of shelf sides. The carrier may be configured to be movably mounted to the guide rail.

In an example, the cable includes a first end and a second end. The first end of the cable may be configured to be connected to the carrier. The second end of the cable may be a free end.

In an example, the driver may be configured to push and pull the cable to enable the covering shelf to cover or uncover the luggage compartment.

In an example, the guide rail may include a rail groove formed in a longitudinal direction. The carrier and the cable are movably inserted into the rail groove. An inner surface of the rail groove may form a boundary surface configured to restrict bending of the cable.

In an example, the cable may be formed of a spiral cable.

In an example, the driver may include a gear and a motor.

In an example, the gear may be configured to transmit force to the cable while contacting the cable.

In an example, the motor may be configured to rotate the gear.

In an example, the guide rail and the driver may be vertically spaced apart from each other.

In an example, the cable may undergo elastic bending deformation between the guide rail and the driver.

In an example, the covering shelf may move in a first direction to cover the luggage compartment.

In an example, the guide rail may include a main rail and a secondary rail.

In an example, the main rail may be elongated in a straight direction. The main rail has a first-direction end.

In an example, the secondary rail may be connected to the first-direction end of the main rail. The secondary rail has a first-direction end.

In an example, the first-direction end of the secondary rail may be higher than the first-direction end of the main rail such that the height of the first portion of the covering shelf is lowered when the covering shelf starts to uncover the luggage compartment.

In an example, the carrier may include a cable carrier and a shelf carrier.

In an example, the cable carrier may be connected to the cable. The cable carrier may move on the main rail.

In an example, the shelf carrier may be connected to the cable carrier and the first portion. The shelf carrier may move on the main rail and the secondary rail.

In an example, the cable carrier and the shelf carrier may be pivotably coupled to each other.

In an example, the shelf carrier may include a fitting groove into which the first portion is pivotably fitted.

In an example, the luggage compartment may include a first luggage compartment and a second luggage compartment.

In an example, the second luggage compartment may be disposed ahead of the first luggage compartment in the first direction.

In an example, the covering shelf may include a first shelf and a second shelf.

In an example, the first shelf may be configured to cover and uncover the first luggage compartment.

In an example, the second shelf may be configured to be pivotably coupled to an end of the first shelf and may be configured to cover and uncover the second luggage compartment. The second shelf may be provided with the first portion.

In an example, when the covering shelf starts to uncover the luggage compartment, the end of the first shelf may be raised, thereby causing the covering shelf to be folded.

In an example, the main rail may be bent at a predetermined curvature.

In an example, the secondary rail may be configured to be connected to the first-direction end of the main rail.

In an example, the first-direction end of the secondary rail may be higher than the first-direction end of the main rail such that the height of the first portion of the covering shelf is lowered when the covering shelf starts to uncover the luggage compartment.

In an example, a first-direction end of the secondary rail may be inclined upwards as the secondary rail extends in the first direction such that a height of the first portion is lowered when the covering shelf starts to uncover the luggage compartment.

### BRIEF DESCRIPTION OF THE DRAWINGS

The foregoing and other aspects, features, and advantages, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a perspective view from rear and top sides of a covering shelf apparatus for a vehicle according to an embodiment of the present disclosure.

FIG. 2 is a perspective view from rear and bottom sides of a covering shelf apparatus for a vehicle according to an embodiment of the present disclosure viewed.

FIG. 3 is a partially-projected view from a lateral side of a covering shelf apparatus for a vehicle showing a state in which a covering shelf covers a luggage compartment according to an embodiment of the present disclosure.

FIG. 4 is a partially-projected view from a lateral side of a covering shelf apparatus for a vehicle showing a state in which the covering shelf has uncovered a luggage compartment according to an embodiment of the present disclosure.

FIG. 5 is a lateral view of a driver of a covering shelf apparatus for a vehicle according to an embodiment of the present disclosure.

FIG. 6 is a perspective view of a carrier and a guide rail of a covering shelf apparatus for a vehicle according to an embodiment of the present disclosure.

FIG. 7 is an exploded perspective view of a carrier and a guide rail of a covering shelf apparatus for a vehicle according to an embodiment of the present disclosure.

FIGS. 8 to 11 are views depicting simplified versions of a guide rail in a covering shelf apparatus for a vehicle according to an embodiment of the present disclosure.

FIGS. 12 and 13 are lateral partially-projected views of a covering shelf apparatus for a vehicle according to an embodiment of the present disclosure.

### DETAILED DESCRIPTION

Hereinafter, embodiments of the present disclosure are described in detail with reference to the accompanying drawings. Description of known functions or configurations incorporated herein for description of the present disclosure may be omitted from the description of embodiments of the present disclosure.

An X-direction, a Y-direction, and a Z-direction described in embodiments of the present disclosure may be directions perpendicular to one another. The X- direction and the Y-direction may be directions parallel to a horizontal direction, respectively, and the Z-direction may be a direction parallel to a vertical direction. When the X-direction is a direction parallel to a left/right direction, the Y-direction may be a direction parallel to a forward/rearward direction. When the X-direction is a direction parallel to the forward/rearward direction, the Y-direction may be a direction parallel to the left/right direction.

When a component, device, element, or the like of the present disclosure is described as having a purpose or performing an operation, function, or the like, the component, device, element, or the like should be considered herein as being "configured to" meet that purpose or to perform that operation or function. Each of the component, device, element, and the like may separately embody or be included with a processor and a memory, such as a non-transitory computer readable media, as part of the apparatus.

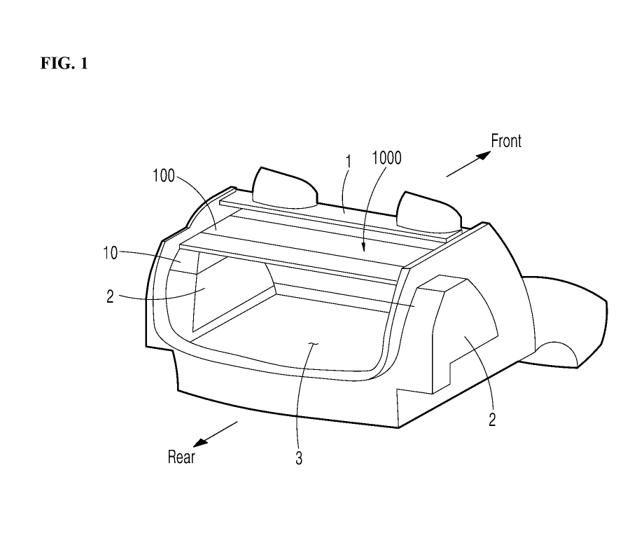

FIG. 1 is a perspective view of a covering shelf apparatus 1000 for a vehicle according to an embodiment of the present disclosure viewed from rear and top sides.

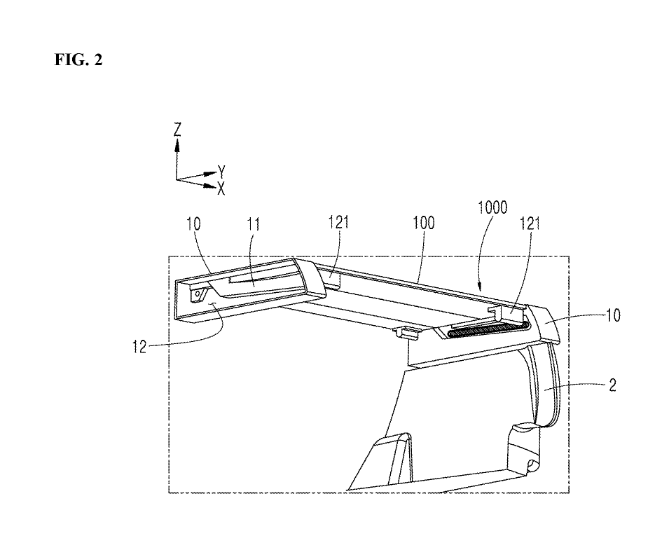

FIG. 2 is a perspective view of the covering shelf apparatus 1000 for a vehicle according to an embodiment of the present disclosure viewed from rear and bottom sides.

Hatchback type vehicles such as sport utility vehicles (SUVs) and crossover utility vehicles (CUVs) are not equipped with a separate luggage compartment. Instead, such vehicles use a space between a rear seat 1 and a tailgate as a luggage compartment 3. Accordingly, a covering shelf configured to shield a passenger compartment, in which a passenger rides, and the luggage compartment 3 from each other may be provided between the rear seat 1 and the luggage compartment 3.

The covering shelf apparatus 1000 for a vehicle according to an embodiment of the present disclosure may include a shelf side 10 and a covering shelf 100.

The shelf side 10 may be provided at each of left and right sides of the luggage compartment 3. A luggage side trim 2 may be provided at each of the left and right sides of the luggage compartment 3. The shelf side 10 may be provided over the luggage side trim 2.

The shelf side 10 may be coupled to an upper portion of the luggage side trim 2 by bolts, and the like. Alternatively, the shelf side 10 may be manufactured to be integrated with the luggage side trim 2.

The covering shelf 100 may cover (e.g., close) and uncover (e.g., open) an upper portion of the luggage compartment 3. The covering shelf 100 may cover the luggage compartment 3 through movement thereof in a first direction Y. The covering shelf 100 may uncover the luggage compartment 3 through movement thereof in a direction -Y opposite to the first direction Y (referred to as a "second direction" hereinafter). The first direction Y may mean a rear side of a vehicle. The second direction may mean a front side of the vehicle.

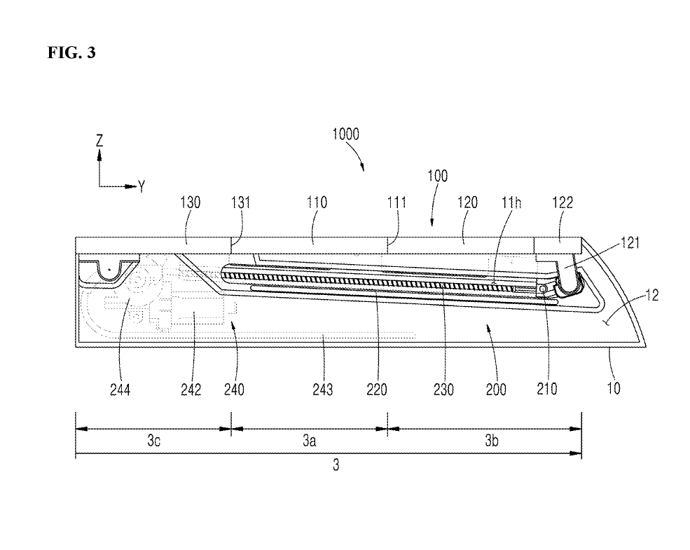

FIG. 3 is a partially-projected view of the covering shelf apparatus 1000 for a vehicle according to an embodiment of the present disclosure viewed from a lateral side, showing a state in which the covering shelf 100 covers the luggage compartment 3 (referred to as a "first state" hereinafter).

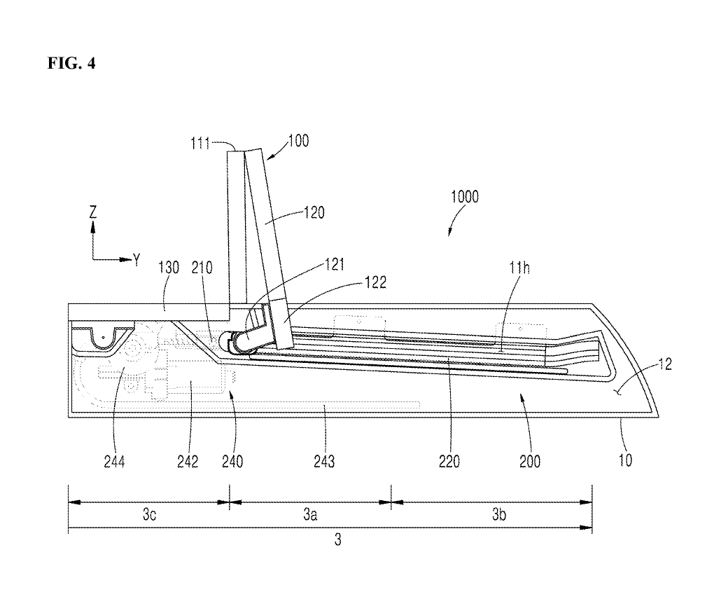

FIG. 4 is a partially-projected view of the covering shelf apparatus 1000 for a vehicle according to an embodiment of the present disclosure viewed from a lateral side, showing a state in which the covering shelf 100 has opened the luggage compartment 3 (referred to as a "second state" hereinafter).

The luggage compartment 3 may include a first luggage compartment 3a and a second luggage compartment 3b. The first luggage compartment 3a and the second luggage compartment 3b may be interconnected. The second luggage compartment 3b may be disposed farther ahead in the first direction Y than the first luggage compartment 3a.

The covering shelf 100 may include a first shelf 110, a second shelf 120, and a third shelf 130.

The first shelf 110 may cover and open the first luggage compartment 3a. The first shelf 110 may form a wide rectangular flat plate shape.

The second shelf 120 may cover and open the second luggage compartment 3b. The second shelf 120 may form a wide rectangular flat plate shape. The second shelf 120 may be pivotably coupled to an end 111 of the first shelf 110 (referred to as a "first end" hereinafter). The first shelf 110 and the second shelf 120 may be interconnected by fabric, leather, a hinge, and the like.

The second shelf 120 may have a portion 121 connected to a carrier 210 (referred to as a "first portion" hereinafter). The first portion 121 may be provided at a lower portion of the second shelf 120 in the first state. The first portion 121 may be provided at an end 122 of the second shelf 120 in the first direction Y.

The third shelf 130 may cover the luggage compartment 3 at a position farther ahead of the first shelf 110 toward the front side of the vehicle. The third shelf 130 may form a wide rectangular flat plate shape. The first shelf 110 may be pivotably coupled to an end 131 of the third shelf 130 (referred to as a "third end" hereinafter). The first shelf 110 and the third shelf 130 may be interconnected by fabric, leather, a hinge, and the like.

Referring to FIG. 3, when the covering shelf 100 starts to close the luggage compartment 3 in the first state, the first end 111 is lowered and, as such, the first shelf 110 and the second shelf 120 may be unfolded

Referring to FIG. 4, when the covering shelf 100 starts to open the luggage compartment 3 in the second state, the first end 111 is raised and, as such, the covering shelf 100 may be folded.

In both the first state (see FIG. 3) and the second state (see FIG. 4), the third shelf 130 may be maintained in a state of covering the luggage compartment 3.

The covering shelf apparatus 1000 for a vehicle according to an embodiment of the present disclosure may include an actuator 200. The actuator 200 may be provided at one of the shelf sides 10. FIG. 2 shows a state in which the actuator 200 is provided at the right shelf side 10.

Each shelf side 10 may include a space in which parts such as the actuator 200, and the like, are installed (referred to an "installation space 12" hereinafter) (see FIG. 2). A side surface 11 of the shelf side 10 may partition the luggage compartment 3 and the installation space 12 from each other.

The actuator 200 may move the covering shelf 100 to enable the covering shelf 100 to cover (e.g., close) or uncover (e.g., open). The actuator 200 may include a carrier 210, a guide rail 220, a cable 230, and a driver 240.

The guide rail 220 may be coupled to the side surface 11 of the shelf side 10. The carrier 210 may be movably mounted to the guide rail 220. A through hole 1 lh may be formed at the side surface 11. The carrier 210 mounted to the guide rail 220 may be exposed to the luggage compartment 3 through the through hole 1lh. The carrier 210 may be connected to the first portion 121 of the covering shelf 100 through the through hole llh.

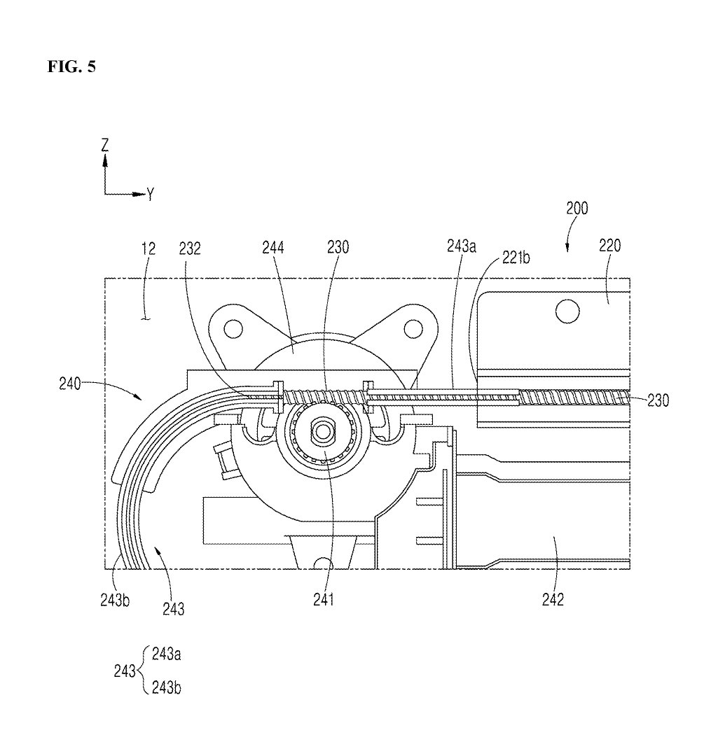

FIG. 5 is a view of the driver 240 of the covering shelf apparatus 1000 for a vehicle according to an embodiment of the present disclosure viewed at a lateral side.

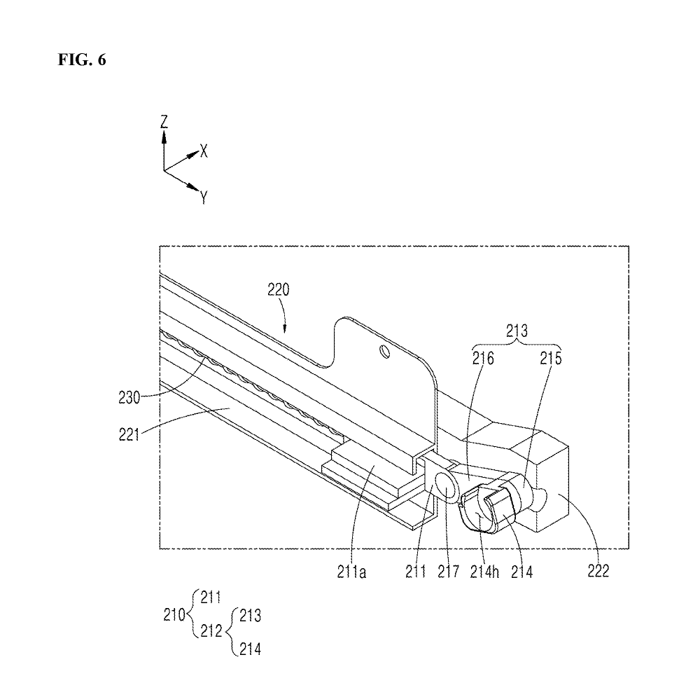

FIG. 6 is a perspective view of a part of the covering shelf apparatus 1000 for a vehicle according to an embodiment of the present disclosure, showing the carrier 210 and the guide rail 220.

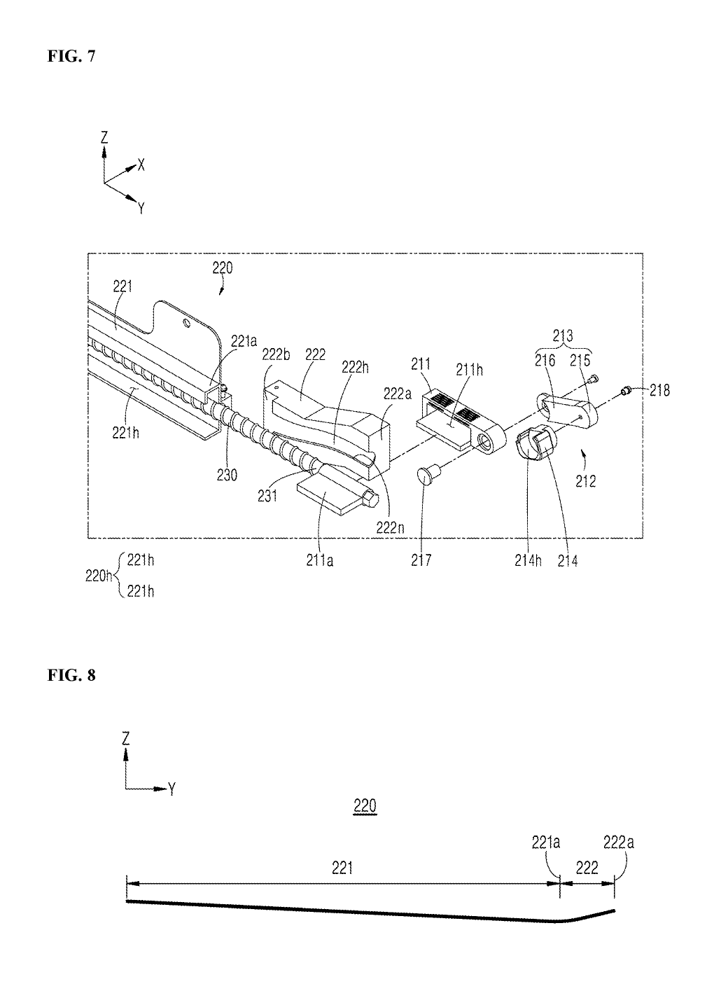

FIG. 7 is an exploded perspective view of a part of the covering shelf apparatus 1000 for a vehicle according to an embodiment of the present disclosure, showing the carrier 210 and the guide rail 220.

The guide rail 220 may include a rail groove 220h extending in a longitudinal direction of the guide rail 220. The carrier 210 and the cable 230 are movably inserted into the rail groove 220h. The guide rail 220 may include a main rail 221 and a secondary rail 222. The secondary rail 222 includes a first-direction end 222a and a second-direction end 222b.

The main rail 221 may be elongated in a straight direction. The straight direction (longitudinal direction) may be inclined downwards (e.g., lowered along the Z- direction) as the main rail 221 extends in the first direction Y. Additionally, the main rail 221 may include a first-direction end 221a and a second-direction end 221b.

A rail groove 221h of the main rail 221 (referred to as a "first rail groove 221h" hereinafter) may be open toward the luggage compartment 3. The cross-section of the main rail 221 may form substantially a "C" shape open toward the luggage compartment 3.

The width of the first rail groove 221h is uniform in a longitudinal direction of the main rail 221. The width of the first rail groove 221h may mean a vertical width with reference to the C-shaped cross-section. An opening of the main rail 221 open toward the luggage compartment 3 may have a smaller vertical width than the vertical width of the first rail groove 221h. Accordingly, separation of the carrier 210 and the cable 230 may be prevented.

The secondary rail 222 may be connected to an end (e.g., the first- direction end) 221a of the main rail 221 in the first direction Y. An end (e.g., the first- direction end) 222a of the secondary rail 222 in the first direction Y may be elevated higher (e.g., in the Z direction) than the first-direction end of the main rail 221 in the first direction Y. The secondary rail 222 may be inclined upwards as the secondary rail 222 extends in the first direction Y.

The second-direction end 222b of secondary rail 222 may be coupled to the first-direction end 221a of the main rail 221 in the first direction Y by a bolt. Alternatively, the main rail 221 and the secondary rail 222 may be manufactured to be integrated with each other.

A rail groove 222h of the secondary rail 222 (referred to as a "second rail groove 222h" hereinafter) may be open toward the luggage compartment 3. The cross- section of the secondary rail 222 may form substantially a "C" shape open toward the luggage compartment 3.

The width of the second rail groove 222h is uniform in a longitudinal direction of the secondary rail 222. The width of the second rail groove 222h may be equal to the width of the first rail groove 221h. The width of the second rail groove 222h may mean a vertical width with reference to the C-shaped cross-section. An opening 222n of the secondary rail 222 may have a smaller vertical width than the vertical width of the second rail groove 222h. Accordingly, separation of the carrier 210 and the cable 230 may be prevented.

The carrier 210 may include a cable carrier 211 and a shelf carrier 212.

The cable carrier 211 may form a longitudinally-elongated rectangular parallelepiped shape. The cable carrier 211 may have a slightly smaller vertical width than the vertical width of the first rail groove 221h. Accordingly, the cable carrier 211 may move in the first rail groove 221h in the longitudinal direction of the main rail 221.

The second rail groove 222h may be inclined upwards as the second rail groove 222h extends in the first direction Y. Accordingly, movement of the rectangular parallelepiped cable carrier 211 from the first rail groove 221h to the second rail groove 222h may be restricted.

The cable carrier 211 may form a hole 211h in which a fastening piece is fitted (referred to as a "fastening hole 211h" hereinafter). When one end (e.g., a first end) 231 of the cable 230 is inserted into the cable carrier 211, the fastening piece may be coupled to (fitted in) through the fastening hole 21lh. Accordingly, the end of the cable 230 may be connected to the cable carrier 211. The other end (e.g., a second end) 232 of the cable 230 may be a free end.

The shelf carrier 212 may include a carrier body 213 and a fitting 214.

The carrier body 213 may include a cylindrical portion 215 and a connecting portion 216.

The cylindrical portion 215 may form a cylindrical shape having a central axis parallel to an X-axis. The cylindrical portion 215 may have a diameter slightly smaller than the width of the second rail groove 222h. Accordingly, although a bottom surface of the second rail groove 222h is inclined upwards as the second rail groove 222h extends in the first direction Y, the cylindrical portion 215 may move on the main rail 221 and the secondary rail 222.

The connecting portion 216 may extend from the cylindrical portion 215. The cable carrier 211 and the connecting portion 216 may be pivotably interconnected by a hinge (referred to as a "connecting hinge 217" hereinafter). The connecting portion 216 may form a bar shape having a thickness smaller than the diameter of the cylindrical portion 215. Accordingly, although the second rail groove 222h is inclined upwards as the second rail groove 222h extends in the first direction Y, the connecting portion 216 may move on the main rail 221 and the secondary rail 222.

The fitting 214 may be coupled to the cylindrical portion 215 by a fastener 218 such as a bolt, and the like. The fitting 214 may form a groove in which the first portion 121 is downwardly fitted (referred to as a "fitting groove 214h" hereinafter). The first portion 121 may form a cylindrical shape having a central axis parallel to the X-axis. An inner diameter of the fitting groove 214h may be slightly greater than the diameter of the first portion 121. Accordingly, the first portion 121 may be pivotably fitted in (connected to) the fitting groove 214h.

The cable 230 may be movably inserted into the rail groove 220h at the end of the guide rail 220 in the second direction. A C-shaped inner surface of the rail groove 220h may form a boundary surface restricting bending of the cable 230. Accordingly, the cable 230 may smoothly move in the rail groove 220h in the longitudinal direction of the guide rail 220.

The driver 240 may push and pull the cable 230 to enable the covering shelf 100 to cover and open the luggage compartment 3. The driver 240 may be coupled to the side surface 11 of the shelf side 10. The driver 240 may include a gear 241, a motor 242, and a cable guide 243. The gear 241 an output-side gear of a gear box 244.

The gear 241 may be spaced apart from the second-direction end of the guide rail 220 in the second direction. The cable 230 may be formed of a spiral cable. Teeth of the gear 241 may contact a twisty surface of the spiral cable.

Accordingly, the gear 241 may transmit force to the cable 230 as the gear 241 contacts the cable 230. As such, the cable 230 may be moved by the gear 241. The motor 242 may rotate the gear 241.

The cable guide 243 may guide movement of the cable 230 outside of the guide rail 220. The cable guide 243 may be formed of a tube into which the cable 230 is movably inserted. One side of the cable guide 243 may be coupled to the gear box 244.

One end of the cable guide 243 may be inserted into the rail groove 220h at the second-direction end of the guide rail 220. The other end of the cable guide 243 may be disposed at one side of the installation space 12 of the shelf side 10.

The cable guide 243 may include a first cable guide 243a and a second cable guide 243b. The first cable guide 243a and the second cable guide 243b may be spaced apart from each other. The cable 230 may contact the gear 241 between the first cable guide 243a and the second cable guide 243b. The first cable guide 243a may include one end of the cable guide 243. The second cable guide 243b may include the other end of the cable guide 243.

The cable guide 243 may include a straight section elongated in one direction and a curved section bent in the form of a curved line in accordance with a shape of the installation space 12. The second cable guide 243b may include the curved section.

As the radius of curvature of the curved section decreases, the bending strain and frictional force of the cable 230 may increase. Accordingly, the radius of curvature of the curved section may be determined within a range in which the bending strain and frictional force of the cable 230 do not increase load of the motor 242.

A guide tube configured to guide a movement path of the cable 230 may be installed between the guide rail 220 and the driver 240. Accordingly, the cable 230 may undergo elastic bending deformation between the guide rail 220 and the driver 240.

When the gear 241 rotates in a counterclockwise direction with reference to the second state depicted in FIG. 4, the cable 230 may be moved on the guide rail 220 in the second direction. Accordingly, the carrier 210 may be moved on the guide rail 220 in the second direction, and the first end 111 is raised such that the covering shelf 100 is folded. As a result, the covering shelf 100 may open the luggage compartment 3.

When the cable 230 moves on the guide rail 220 in the second direction, the cable 230 may move in the cable guide 243 toward the other end of the cable guide 243. The other end of the cable 230 may partially protrude through an opening at the other end of the cable guide 243.

When the gear 241 rotates in a clockwise direction with reference to a first state of FIG. 3, the cable 230 may be moved on the guide rail 220 in the first direction Y. Accordingly, the carrier 210 may be moved on the guide rail 220 in the first direction Y. Accordingly, the first end 111 is lowered and, as such, the covering shelf 100 is unfolded. As a result, the covering shelf 100 may close the luggage compartment 3.

When the cable 230 moves on the guide rail 220 in the first direction Y with reference to the first state of FIG. 3, the cable 230 may move in the cable guide 243 toward one end of the cable guide 243. Thus, the movement length of the cable 230 may approximately correspond to the length of an operating range (a movement range of the carrier 210 on the guide rail 220). Accordingly, it may be possible to minimize the length of the cable 230, to reduce the number of parts, and to achieve structural simplification and weight reduction.

FIG. 8 is a view showing the guide rail 220 according to an embodiment of the present disclosure. FIG. 8 depicts a simplified version of the guide rail 220 represented as a line (curve).

The covering shelf may be unfolded substantially in a horizontal direction in a state of closing the luggage compartment 3 (a first state) (see FIG. 3). In the first state, accordingly, the center of gravity of the first shelf 110 and the second shelf 120 may be spaced apart farthest from respective ends thereof in a horizontal direction. In addition, static frictional force is greater than kinetic frictional force. Thus, the greatest load may be applied to the motor 242 when the covering shelf starts to open the luggage compartment 3.

The first-direction end 222a of the secondary rail 222 in the first direction Y may be elevated higher (e.g., in the Z direction) than the first-direction end 221a of the

main rail 221 in the first direction Y. The secondary rail 222 may be inclined upwards as the secondary rail 222 extends in the first direction Y. Accordingly, when the covering shelf 100 starts to open the luggage compartment 3, the height of the first portion 121 may be lowered by a downward inclination of the secondary rail 222 (referred to as a "first downward inclination" hereinafter).

Static frictional force may be reduced by the first downward inclination of the secondary rail 222. In addition, as the height of the first portion 121 is lowered, the second shelf 120 may easily pivot in a folding direction. Accordingly, when the covering shelf 100 starts to open the luggage compartment 3, load applied to the motor 242 may be reduced.

Thus, it may be possible to reduce load in an initial stage of operation and to reduce output and noise of the motor 242. In addition, there may be an advantage in terms of weight and cost reduction of the whole system.

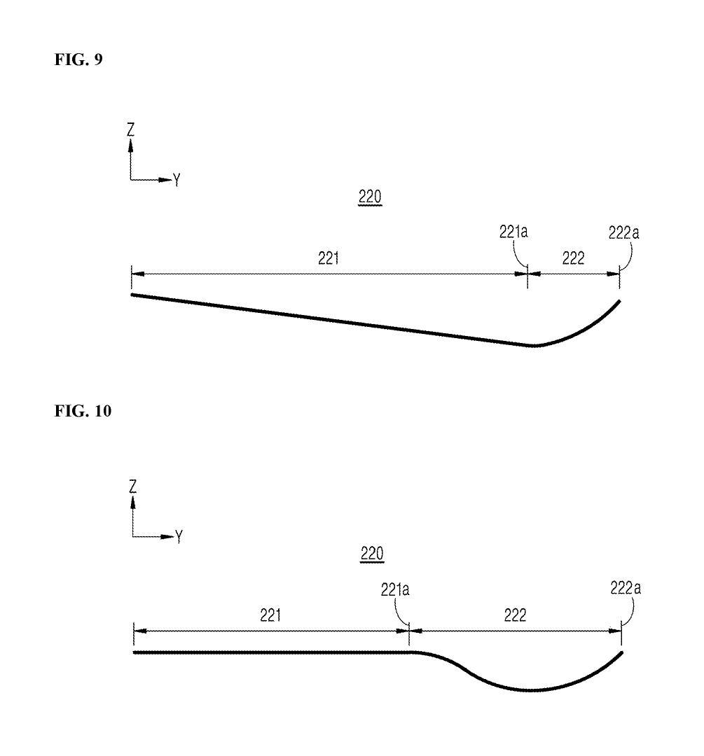

FIG. 9 is a view showing the guide rail 220 according to an embodiment of the present disclosure. FIG. 9 is a view showing another implementation of the guide rail 220 simply illustrated as a line (curve).

The first-direction end 222a of the secondary rail 222 in the first direction Y may be elevated higher (e.g., in the Z direction) than the first-direction end 221a of the main rail 221 in the first direction Y. The secondary rail 222 may be inclined upwards as the secondary rail 222 extends in the first direction Y. Accordingly, when the covering shelf 100 starts to open the luggage compartment 3, the height of the first portion 121 may be lowered by a downward inclination of the secondary rail 222 (referred to as a "second downward inclination" hereinafter) (see FIG. 3).

The second downward inclination may be greater than the first downward inclination. Accordingly, static frictional force may be further reduced by the second downward inclination of the secondary rail 222. In addition, as the height of the first portion 121 is further lowered, the second shelf 120 may more easily pivot in the folding direction.

Accordingly, when the covering shelf 100 starts to open the luggage compartment 3, load applied to the motor 242 may be further reduced. Thus, it may be possible to reduce load in an initial stage of operation and to further reduce output and noise of the motor 242. In addition, there may be an advantage in terms of weight and cost reduction of the whole system.

FIG. 10 is a view showing the guide rail 220 according to an embodiment of the present disclosure. FIG. 10 is a view showing another implementation of the guide rail 220 simply illustrated as a line (curve).

The first-direction end 222a of the secondary rail 222 in the first direction Y may be elevated higher (e.g., in the Z direction) than the first-direction end 221a of the main rail 221 in the first direction Y. Accordingly, when the covering shelf 100 starts to open the luggage compartment 3, the height of the first portion 121 may be lowered by a downward inclination of the secondary rail 222 (referred to as a "third downward inclination" hereinafter) (see FIG. 3).

The third downward inclination may be greater than the first downward inclination. Accordingly, static frictional force may be further reduced by the third downward inclination of the secondary rail 222. In addition, as the height of the first portion 121 is further lowered, the second shelf 120 may more easily pivot in the folding direction.

Accordingly, when the covering shelf 100 starts to open the luggage compartment 3, load applied to the motor 242 may be further reduced. Thus, it may be possible to reduce load in an initial stage of operation and to further reduce output and noise of the motor 242. In addition, there may be an advantage in terms of weight and cost reduction of the whole system.

The secondary rail 222 may be inclined downwards and then be inclined upwards as the secondary rail 222 extends in the first direction Y. In this case, the main rail 221 may be parallel to the horizontal direction. Accordingly, when the covering shelf 100 opens and closes the luggage compartment 3, the range in which the end of the covering shelf 100 is lowered toward the luggage compartment 3 may be reduced. Thus, it may be possible to minimize impact of the covering shelf 100 on articles received in the luggage compartment 3 upon opening and closing the luggage compartment 3.

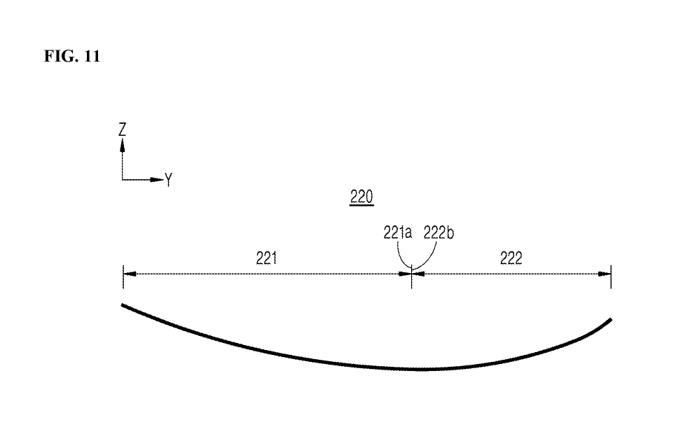

FIG. 11 is a view showing the guide rail 220 according to an embodiment of the present disclosure. FIG. 11 is a view showing another implementation of the guide rail 220 simply illustrated as a line (curve).

The main rail 221 may be bent to have a predetermined curvature. The second-direction end 222b of the secondary rail 222 may be connected to the first- direction end 221a of the main rail 221 in the first direction Y. The secondary rail 222 may be bent to have the same curvature as that of the main rail 221. Accordingly, the covering shelf 100 may smoothly move upon opening and closing the luggage compartment 3 (see FIG. 3).

As the guide rail 220 is manufactured to have various shapes, it may be possible to prevent interference of the guide rail 220 with other parts while realizing various designs and satisfying aesthetic senses of passengers.

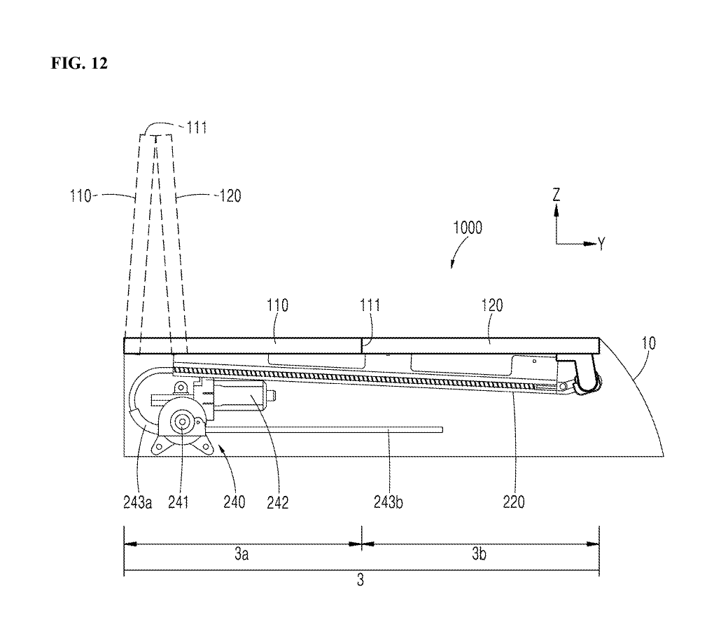

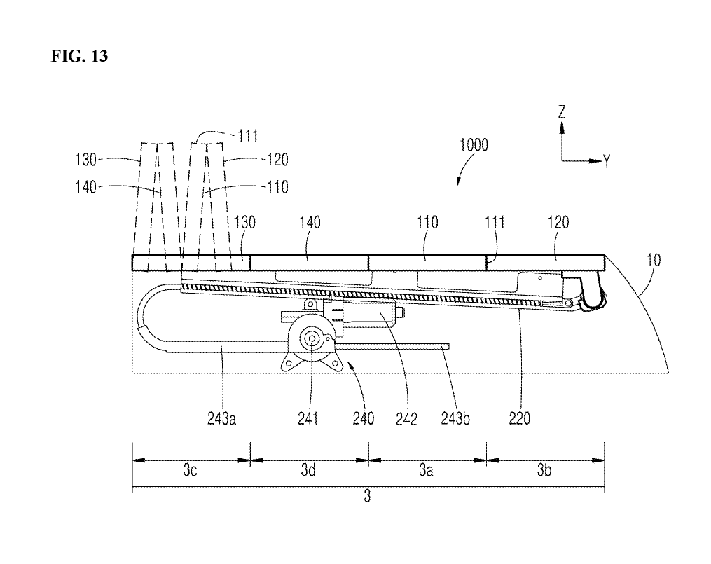

FIGS. 12 and 13 are partially-projected views of the covering shelf apparatus 1000 for a vehicle according to an embodiment of the present disclosure viewed from a lateral side.

The guide rail 220 and the driver 240 may be vertically spaced apart from each other. Accordingly, it may be possible to manufacture the guide rail 220 to have an increased length. Thus, the covering shelf 100 may cover and open an increased area.

The covering shelf 100 may include a first shelf 110 and a second shelf 120.

The first shelf 110 may cover and open a first luggage compartment 3a. The second shelf 120 may cover and open a second luggage compartment 3b.

The first shelf 110 may be pivotably coupled to the shelf side 10. The second shelf 120 may be pivotably coupled to a first end 111 of the first shelf 110. The second shelf 120 may be provided with a first portion 121 and, as such, may be connected to a carrier 210. When the covering shelf 100 starts to open the luggage compartment 3 from the first state, the first end 111 is raised and, as such, the covering shelf 100 may be folded as shown in the second state.

Alternatively, the covering shelf 100 may include a first shelf 110, a second shelf 120, a third shelf 130, and a fourth shelf 140. The first shelf 110 may cover and open a first luggage compartment 3a. The second shelf 120 may cover and open a second luggage compartment 3b. The third shelf 130 may cover and open a third luggage compartment 3c. The fourth shelf 140 may cover and open a fourth luggage compartment 3d.

The third shelf 130 may be pivotably coupled to the shelf side 10. The third shelf 130, the fourth shelf 140, the first shelf 110, and the second shelf 120 may be sequentially pivotably coupled to one another. When the covering shelf 100 starts to open the luggage compartment 3 in the first state, the first end 111 is raised and, as such, the first shelf 110 and the second shelf 120 may be folded. Subsequently, the third shelf 130 and the fourth shelf 140 may be folded while being pushed by the first shelf 110 and the second shelf 120.

The motor 242 and the gear 241 may be disposed at a second-direction end of the installation space 12 in accordance with design conditions (positions, specifications, and the like) of the shelf side 10 and the actuator 200. In this case, the first cable guide 243a may include a curved section. The second cable guide 243b may include a straight section.

The motor 242 and the gear 241 may be disposed farther ahead in the first direction Y in accordance with design conditions (positions, specifications, and the like) of the shelf side 10 and the actuator 200. In this case, the first cable guide 243a may include a curved section and a straight section. The second cable guide 243b may include a straight section.

It should be apparent from the above description, in accordance with the covering shelf apparatus for a vehicle according to the embodiments of the present disclosure, the cable may be formed of a spiral cable. Teeth of the gear may contact a twisty surface of the spiral cable. Accordingly, the gear may transmit force to the cable as the gear contacts the cable. When the cable moves on the guide rail in the second direction, the cable may move in the cable guide toward the other end of the cable guide. When the cable moves on the guide rail in the first direction, the cable may move in the cable guide toward one end of the cable guide. Thus, the movement length of the cable may correspond to substantially the length of an operating range (a movement range of the carrier on the guide rail). Accordingly, it may be possible to minimize the length of the cable, to reduce the number of parts, and to achieve structural simplification and weight reduction.

In accordance with the covering shelf apparatus for a vehicle according to embodiments of the present disclosure, the cable guide may guide movement of the cable outside of the guide rail. The cable guide may include a straight section elongated in one direction and a curved section bent in the form of a curved line in accordance with a shape of the installation space. As the radius of curvature of the curved section decreases, the bending strain and frictional force of the cable may increase. Accordingly, the radius of curvature of the curved section may be determined within a range in which the bending strain and frictional force of the cable do not increase load of the motor. A guide tube configured to guide a movement path of the cable may be installed between the guide rail and the driver. Accordingly, the cable may undergo uniform elastic bending deformation between the guide rail and the driver.

In accordance with the covering shelf apparatus for a vehicle according to the embodiments of the present disclosure, the cable may be movably inserted into the rail groove at the second-direction end of the guide rail. An inner surface of the rail groove may form a boundary surface restricting bending of the cable. As bending of the cable is restricted in the rail groove, the cable may smoothly move in the rail groove in the longitudinal direction of the guide rail.

In accordance with the covering shelf apparatus for a vehicle according to the embodiments of the present disclosure, the first-direction end of the secondary rail may be higher than the first-direction end of the main rail. The secondary rail may be inclined upwards as the secondary rail extends in the first direction. Accordingly, when the covering shelf starts to open the luggage compartment, the height of the first portion may be lowered by a downward inclination of the secondary rail (referred to as a "first downward inclination" hereinafter). Static frictional force may be reduced by the first downward inclination of the secondary rail. In addition, as the height of the first portion is lowered, the second shelf may easily pivot in a folding direction. Accordingly, when the covering shelf starts to open the luggage compartment, load applied to the motor may be reduced. Thus, it may be possible to reduce load in an initial stage of operation and to reduce output and noise of the motor. In addition, there may be an advantage in terms of weight and cost reduction of the whole system.

In accordance with the covering shelf apparatus for a vehicle according to the embodiments of the present disclosure, the first-direction end of the secondary rail may be higher than the first-direction end of the main rail. The secondary rail may be inclined upwards as the secondary rail extends in the first direction. Accordingly, when the covering shelf starts to open the luggage compartment, the height of the first portion

may be lowered by a downward inclination of the secondary rail (referred to as a "second downward inclination" hereinafter). The second downward inclination may be greater than the first downward inclination. Accordingly, static frictional force may be further reduced by the second downward inclination of the secondary rail. In addition, as the height of the first portion is further lowered, the second shelf may more easily pivot in the folding direction. Accordingly, when the covering shelf starts to open the luggage compartment, load applied to the motor may be further reduced. Thus, it may be possible to reduce load in an initial stage of operation and to further reduce output and noise of the motor. In addition, there may be an advantage in terms of weight and cost reduction of the whole system.

In accordance with the covering shelf apparatus for a vehicle according to the embodiments of the present disclosure, the secondary rail may be inclined downwards and then be inclined upwards as the secondary rail extends in the first direction. In this case, the main rail may be parallel to the horizontal direction. Accordingly, when the covering shelf opens and closes the luggage compartment, the range in which the end of the covering shelf is lowered toward the luggage compartment may be reduced. Thus, it may be possible to minimize impact of the covering shelf on articles received in the luggage compartment upon opening and closing the luggage compartment.

In accordance with the covering shelf apparatus for a vehicle according to embodiments of the present disclosure, the main rail may be bent to have a predetermined curvature. The secondary rail may be connected to the first-direction end of the main rail. The secondary rail may be bent to have the same curvature as that of the main rail. Accordingly, the covering shelf may smoothly move upon opening and closing the luggage compartment. As the guide rail is manufactured to have various shapes, it may be possible to prevent interference of the guide rail with other parts while realizing various designs and satisfying emotional aspects of passengers.

In accordance with the covering shelf apparatus for a vehicle according to embodiments of the present disclosure, the guide rail and the driver may be vertically spaced apart from each other. Accordingly, it may be possible to manufacture the guide rail to have an increased length. Thus, the covering shelf may cover and open an increased area. The motor and the gear may be disposed at various positions in the installation space in accordance with design conditions (positions, specifications, and the like.) of the shelf side and the actuator.

While embodiments of the present disclosure have been illustrated and described above, the present disclosure is not limited to the embodiments described above. Naturally, various modifications can be made within the scope of the present disclosure by a person having ordinary skill in the art to which the disclosure belongs. Such modifications should not be understood individually from the technical idea and prospects of the present disclosure, and are within the scope of the present disclosure as claimed in the claims.

What is claimed is:

1. A covering shelf apparatus for a vehicle, the covering shelf apparatus comprising:
a plurality of shelf sides respectively provided at left and right sides of a luggage compartment of the vehicle; and
an actuator provided at one of the plurality of shelf sides and configured to move a covering shelf to uncover or cover the luggage compartment,
wherein the actuator comprises:a carrier configured to be connected to a first portion of the covering shelf,a guide rail configured to be coupled to a respective shelf side of the plurality of shelf sides and configured to move the carrier along the guide rail,a cable having a first end and a second end, the first end of the cable is configured to be connected to the carrier, and the second end of the cable is a free end, anda driver configured to push and pull the cable to move the covering shelf to uncover or cover the luggage compartment.

2. The covering shelf apparatus according to claim 1, wherein:
the guide rail comprises a rail groove formed in a longitudinal direction;
the carrier and the cable are movably inserted into the rail groove; and
an inner surface of the rail groove forms a boundary surface configured to restrict bending of the cable.

3. The covering shelf apparatus according to claim 1, wherein the cable is formed of a spiral cable.

4. The covering shelf apparatus according to claim 3, wherein the driver comprises:
a gear configured to transmit force to the cable while contacting the cable; and
a motor configured to rotate the gear.

5. The covering shelf apparatus according to claim 3, wherein:
the guide rail and the driver are vertically spaced apart from each other; and
the cable undergoes elastic bending deformation between the guide rail and the driver.

6. The covering shelf apparatus according to claim 1, wherein:
the covering shelf moves in a first direction to cover the luggage compartment;
the guide rail comprises:a main rail elongated in a straight direction, the main rail having a first- direction end, anda secondary rail connected to the first-direction end of the main rail, the secondary rail have a first-direction end; and
the first-direction end of the secondary rail is higher than the first-direction end of the main rail such that a height of the first portion of the covering shelf is lowered when the covering shelf starts to uncover the luggage compartment.

7. The covering shelf apparatus according to claim 6, wherein the carrier comprises:
a cable carrier configured to be connected to the cable and configured to move on the main rail; and
a shelf carrier configured to be connected to the cable carrier and the first portion, the shelf carrier being configured to move on the main rail and the secondary rail.

8. The covering shelf apparatus according to claim 7, wherein the cable carrier and the shelf carrier are pivotably coupled to each other.

9. The covering shelf apparatus according to claim 7, wherein the shelf carrier comprises a fitting groove into which the first portion is pivotably fitted.

10. The covering shelf apparatus according to claim 7, wherein:
the shelf carrier further comprises a carrier body having a cylindrical portion and a connecting portion; and
the connecting portion is pivotably coupled to the shelf carrier.

11. The covering shelf apparatus according to claim 6, wherein:
the luggage compartment comprises:a first luggage compartment, anda second luggage compartment disposed ahead of the first luggage compartment in the first direction; and
the covering shelf comprises:a first shelf configured to uncover and cover the first luggage compartment, anda second shelf configured to be pivotably coupled to an end of the first shelf and configured to uncover and cover the second luggage compartment, the second shelf being coupled to the first portion.

12. The covering shelf apparatus according to claim 11, wherein, when the covering shelf starts to uncover the luggage compartment, the end of the first shelf is raised, thereby causing the covering shelf to be folded.

13. The covering shelf apparatus according to claim 1, wherein:
the covering shelf moves in a first direction to cover the luggage compartment;
the guide rail comprises:a main rail configured to be bent at a predetermined curvature, the main rail having a first-direction end, anda secondary rail connected to the first-direction end of the main rail, the secondary rail have a first-direction end; and
the first-direction end of the secondary rail is higher than the first-direction end of the main rail such that a height of the first portion of the covering shelf is lowered when the covering shelf starts to uncover the luggage compartment.

14. The covering shelf apparatus according to claim 1, wherein:
the covering shelf moves in a first direction to cover the luggage compartment;
the guide rail comprises:a main rail elongated in a straight direction, the main rail having a first- direction end, anda secondary rail connected to the first-direction end of the main rail, the secondary rail having a first-direction end; and
the first end of the secondary rail is inclined upwards as the secondary rail extends in the first direction such that a height of the first portion is lowered when the covering shelf starts to uncover the luggage compartment.

15. The covering shelf apparatus according to claim 1, wherein the actuator is configured to move the covering shelf between a first state and a second state.

16. The covering shelf apparatus according to claim 15, wherein in the first state the covering shelf covers the luggage compartment.

17. The covering shelf apparatus according to claim 15, wherein in the second state the covering shelf uncovers the luggage compartment.

18. A covering shelf apparatus for a vehicle, the covering shelf apparatus comprising:
an actuator coupled to a shelf side of a luggage compartment of the vehicle, the actuator being configured to move a covering shelf between a first state and a second state,
wherein the actuator comprises:a carrier configured to be connected to a first portion of the covering shelf;a guide rail configured to be coupled to the shelf side and configured to move the carrier along the guide rail;a cable having a first end and a second end, the first end of the cable is configured to be connected to the carrier, and the second end of the cable is a free end; anda driver configured to push and pull the cable to move the covering shelf between the first state and the second state.

19. The covering shelf apparatus according to claim 18, wherein:
in the first state, the covering shelf moves in a first direction to cover the luggage compartment; and
in the second state, the covering shelf moves in a second direction to uncover the luggage compartment.

20. The covering shelf apparatus according to claim 19, wherein:
the guide rail comprises:a main rail elongated in a straight direction, the main rail having a first- direction end, anda secondary rail connected to the first-direction end of the main rail, the secondary rail have a first-direction end; and
in the first state, the first-direction end of the secondary rail is higher than the first-direction end of the main rail such that a height of the first portion of the covering shelf is lowered when the covering shelf starts to uncover the luggage compartment.
